(19) United States
(12) Patent Application Publication
(10) Pub. No.: US 2002/0131200 A1
(43) Pub. Date: Sep. 19, 2002

(54) Disk apparatus and filter for disk apparatus

(76) Inventor: Yuki Tomioka, Sayama-shi (JP)

Correspondence Address: PILLSBURY WINTHROP, LLP, P.O. BOX 10500, MCLEAN, VA, 22102, US

(21) Appl. No.: 10/091,571

(22) Filed: Mar. 7, 2002

(30) Foreign Application Priority Data
Mar. 14, 2001 (JP) 2001-072925

(51) Int. Cl. G11B 17/02

(52) U.S. Cl. 360/97.02

(57) ABSTRACT

A magnetic disk apparatus includes a casing having a substantially hermetic structure, which houses a magnetic disk, a motor, and a magnetic head. A filter is arranged within the casing. The filter includes an oxidizing agent containing oxidized metal components and serving to oxidize gaseous components, and a trapping agent subjected to the treatment with an alkali, for trapping the acidic gas oxidized by the oxidizing agent.

### CROSS-REFERENCE TO RELATED APPLICATIONS

This application is based upon and claims the benefit of priority from the prior Japanese Patent Application No. 2001-072925, filed Mar. 14, 2001, the entire contents of which are incorporated herein by reference.

### BACKGROUND OF THE INVENTION

1. Field of the Invention

The present invention relates to a disk apparatus, particularly, to a disk apparatus having a chemical filter arranged within the casing and to a filter for a disk apparatus.

2. Description of the Related Art

In general, a disk apparatus, e.g., a hard disk drive (hereinafter referred to as “HDD”) comprises a magnetic disk, a spindle motor for rotating the magnetic disk, a magnetic head for performing read/write of data in and from the magnetic disk, a head suspension assembly for supporting and moving the magnetic head, and a VCM for driving the head suspension assembly. These members of the HDD are housed in a casing of a substantially hermetic structure. In the case of having such a hermetic structure, it is possible to stabilize the flying movement of the magnetic head relative to the magnetic disk during the read/write operation. It is also possible to prevent dust or the like from entering the casing.

However, where the casing is of substantially a hermetic structure as described above, a difference is generated between the inner pressure of the HDD and the outer atmospheric pressure when the ambient temperature is rapidly changed, with the result that the casing tends to be damaged. For preventing this problem, the casing is provided with a fine air hole through which the inner space of the casing is allowed to communicate with the outer atmosphere. Also, a chemical filter for preventing dust or gaseous components from entering the casing from the outside is mounted to the air hole.

In general, an activated charcoal is used for forming the chemical filter of this type to enable the activated charcoal to trap the gaseous components by utilizing the neutralizing (ionic) reaction between an acid and an alkali. For example, if the HDD has an inner volume of 15 cm³ and if a temperature change of about 10° C. takes place during operation of the HDD, about 0.5 cm³ of the outer air flows through the air hole into the casing, as apparent from the Charles' law. The outer air flowing into the casing passes through the chemical filter without fail, with the result that the dust and gaseous components within the outer air are trapped by the chemical filter.

In general, it is undesirable for an acidic gas to be present inside the HDD. Particularly, sulfate ions are adsorbed on the parts of the HDD and are unlikely to be desorbed so as to give rise to the problem that the parts of the HDD are corroded. It is considered reasonable to understand that the sulfate ions adsorbed on the parts of the HDD are derived from the hydrogen sulfide ions coming from the outer air.

Hydrogen sulfide is chemically stable and is unlikely to be ionized, with the result that the activated charcoal fails to trap hydrogen sulfide efficiently. It follows that hydrogen sulfide enters the HDD without being trapped by the chemical filter so as to be accumulated within the HDD. Hydrogen sulfide entering the HDD is low in reactivity under room temperature and atmospheric pressure. However, if the inside of the HDD is subjected to a high temperature and a high humidity, hydrogen sulfide begins to be oxidized into sulfur dioxide and, then, into sulfuric acid. It should be noted that sulfuric acid is highly reactive and, thus, is attached to the surfaces of the parts of the HDD. Sulfuric acid once attached to the parts within the HDD is scarcely desorbed, with the result it is highly possible for the parts of the HDD to be corroded by the attached sulfuric acid.

### BRIEF SUMMARY OF THE INVENTION

An object of the present invention, which has been achieved in view of the situation described above, is to provide a disk apparatus capable of efficiently eliminating the gaseous components such as hydrogen sulfide, ammonia and nitrogen monoxide so as to improve the reliability of the disk apparatus, and a filter for a disk apparatus.

According to an aspect of the present invention, which has been developed for achieving the object noted above, there is provided a disk apparatus, comprising a motor configured to support and drive a disk; a head configured to read information from the disk; a casing of a substantially hermetic structure, which houses the disk, the motor, and the head; and a filter arranged within the casing; wherein the filter includes an oxidizing agent containing the oxidized metal components and serving to oxidize the gaseous components and a trapping agent for trapping the acidic gas oxidized by the oxidizing agent.

A filter for a disk apparatus according to another aspect of the present invention, comprises an oxidizing agent containing oxidized metal components and serving to oxidize gaseous components in a casing of the disk apparatus; and a trapping agent subjected to the treatment with an alkali, for trapping the acidic gas oxidized by the oxidizing agent.

Additional objects and advantages of the present invention will be set forth in the description which follows, and in part will be obvious from the description, or may be learned by practice of the present invention. The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention, and together with the general description given above and the detailed description of the embodiments given below, serve to explain the principles of the present invention.

FIG. 1 is an exploded perspective view showing an HDD according to a first embodiment of the present invention;

FIG. 2 is a cross sectional view showing the construction of a chemical filter arranged within the casing of the HDD shown in FIG. 1;

FIG. 3 is a cross sectional view showing the construction of a chemical filter arranged in an HDD according to a second embodiment of the present invention;

FIG. 4 is a cross sectional view showing the construction of a chemical filter arranged in an HDD according to a third embodiment of the present invention;

FIG. 5 is a schematic view showing in a magnified fashion the oxidizing agent and the trapping agent included in the chemical filter according to the third embodiment of the present invention; and

FIG. 6 is a plan view schematically showing a modification of the arrangement of the chemical filter used in the HDD of the present invention.

### DETAILED DESCRIPTION OF THE INVENTION

An embodiment of the present invention, in which a magnetic disk apparatus of the present invention is applied to an HDD, will now be described in detail with reference to the accompanying drawings.

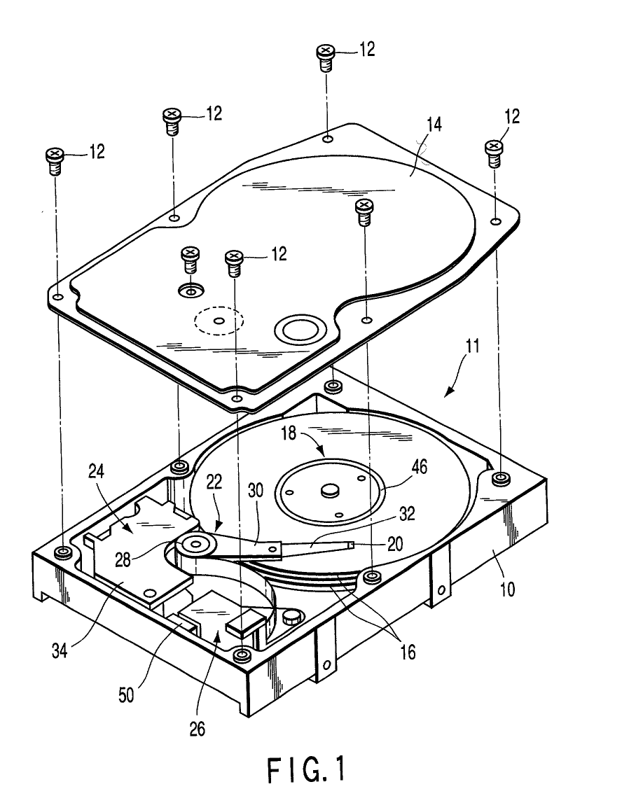

As shown in FIG. 1, an HDD comprises a casing 11 of a substantially hermetic structure, which includes a case body 10 and a top cover 14. The case body 10 is formed in the shape of a rectangular box having an upper opening, and the top cover 14 is screwed to the case body 10 with a plurality of screws 12 so as to close the upper opening of the case body 10.

Housed in the case body 10 are two magnetic disks 16 each acting as a magnetic recording medium, a spindle motor 18 for supporting and rotating these magnetic disks 16, a plurality of magnetic heads 20 for performing read/write of information in and out of the magnetic disks 16, a carriage assembly 22 supporting these magnetic heads 20, a voice coil motor 24 (hereinafter referred to as VCM) for rotating and determining the position of the carriage assembly 22, a substrate unit 26 having a pre-amplifier, etc. Also, a printed circuit board (not shown) for controlling the operations of the spindle motor 18, the VCM 24 and the magnetic head 20 is screwed to the outer surface of the bottom wall of the case body 10.

The carriage assembly 22 includes a substantially cylindrical bearing assembly 28 fixed to the bottom wall of the case body 10 and four sets of head suspension assemblies rotatably supported by the bearing assembly 28. Each of these head suspension assemblies includes an arm 30 extending from the bearing assembly 28 toward the magnetic head 16, and a elongate suspension 32 fixed to the extended end of the arm 30. Also, the magnetic head 20 is mounted on the distal end portion of the suspension 32 with a slider (not shown) interposed therebetween.

The four sets of the head suspension assemblies are arranged such that two magnetic heads 20 are allowed to face each other with the magnetic disk 16 interposed therebetween. It follows that, if the carriage assembly 22 is swung about the bearing assembly 28, each magnetic head 20 is moved to a desired track of the corresponding magnetic disk 16.

The VCM 24 includes a pair of yokes 34 fixed to the bottom wall of the case body 10, a permanent magnet (not shown) fixed to the inner surface of one of the paired yokes 34, and a voice coil (not shown) fixed to the carriage assembly and movable between one of yokes 34 and the permanent magnet. If an electric power is supplied to the voice coil, a magnetic field is generated, with the result that the carriage assembly 22 is swung by the mutual action between the magnetic field generated from the voice coil and the magnetic field generated from the permanent magnet.

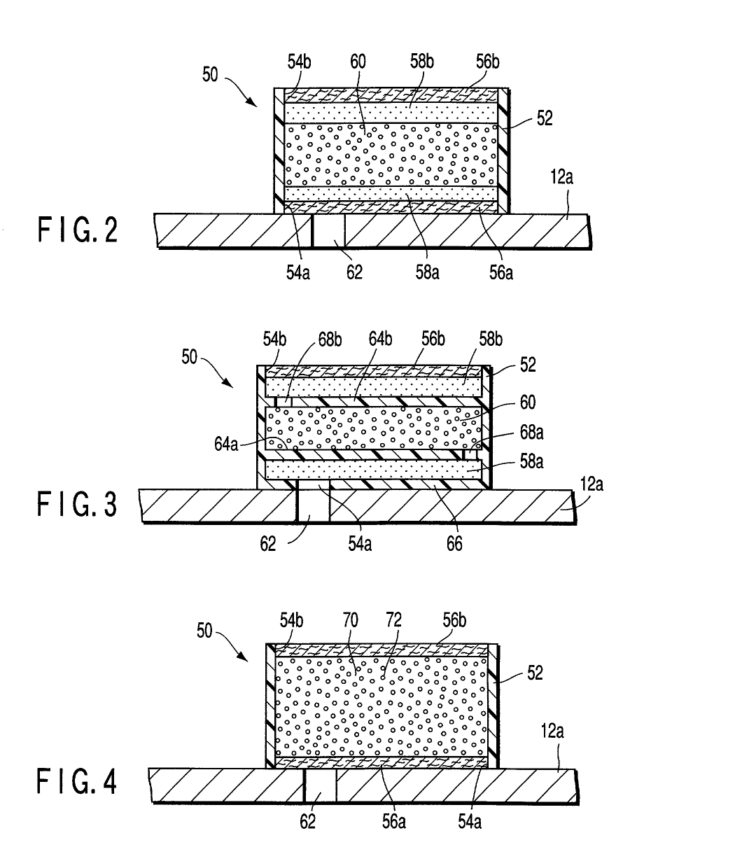

On the other hand, as shown in FIGS. 1 and 2, a chemical filter 50 for trapping the gaseous component generated inside and outside the casing, e.g., a hydrogen sulfide gas, is arranged on the bottom wall 12a of the case body 12 within the casing 11. The chemical filter 50 is positioned close to the substrate unit 26.

As shown in FIG. 2, the chemical filter 50 includes a hollow rectangular container 52 formed of, for example, a synthetic resin. The opening on the side of one end of the container 52 forms a first air passage port 54a, and the opening on the side of the other end of the container 53 forms a second air passage port 54b. These first and second air communication ports 54a, 54b are closed, respectively, by first and second filters 56a, 56b each formed of a resin material such as polypropylene or polycarbonate. These first and second filters 56a, 56b perform the function of permeable lids and also perform the function of collecting dust.

Housed in the container 52 are a first oxidizing section 58a, a trapping section 60, and a second oxidizing section 58b, which are arranged to form a three layer structure. The first oxidizing section 58a includes an oxidizing agent for oxidizing the gaseous component and is disposed on the first filter 56a in a manner to close the first air passage port 54a. The second oxidizing section 58b includes an oxidizing agent for oxidizing the gaseous component and is disposed on the second filter 56b in a manner to close the second air passage port 54b. Also, the trapping section 60 includes a trapping agent for trapping an oxide gas and is sandwiched between the first and second oxidizing sections 58a and 58b.

Each of the first and second oxidizing sections 58a, 58b is formed of 5 mg of, for example, a powdery cobalt oxide (Co₂O₃) used as an oxidizing agent. The oxidizing agent formed of a IVA to IIB group metal promotes the oxidizing reaction of hydrogen sulfide. However, in view of the catalytic function, it is desirable for the oxidizing agent to be formed of any one of the VIIA to VIIIA group metals (Ma, Te, Re, Fe, Co, Ni, Ru, Rh, Pd, Os, Ir, Pt) or to be formed of a desired combination of these metals.

The trapping section 60 is formed of 15 mg of an activated charcoal treated with an alkali. It is also possible to use as the trapping agent alumina particles, fibrous materials, etc., which are treated with an alkali.

On the other hand, an air communication hole 62 for allowing the inner space of the casing 11 to communicate with the outer atmosphere is formed in the bottom wall 12a of the case body 12. The chemical filter 50 is fixed on the bottom wall 12a in a manner to close the air communication hole 62. In the embodiment shown in the drawing, the chemical filter 50 is arranged such that the air communication hole 62 is surrounded by the container 52 under the state that the first filter 56a is in contact with the inner surface of the bottom wall 12a. As a result, the first air passage port 54a of the chemical filter 50 communicates with the air communication hole 62 through the first filter 56a, and the second air passage port 54b communicates with the inner space of the casing 11 through the second filter 56b. It follows that the air circulated inside and outside the casing 11 through the air communication hole 62 is allowed to pass through the chemical filter 50.

For example, the outer air entering the casing 11 through the air communication hole 62 passes through the first filter 56a, the first oxidizing section 58a, the trapping section 60 and the second oxidizing section 58b so as to flow into the casing 11 through the second filter 56b. When the outer air passes through the first oxidizing section 58a, the gaseous component contained in the outer air, e.g., a hydrogen sulfide gas, is oxidized by the oxidizing agent so as to form sulfur dioxide or sulfate ions. When the outer air passes through the trapping section 60, the sulfur dioxide and sulfate ions thus formed are trapped by the trapping section 60 by the neutralizing (ionic) reaction with the trapping agent subjected to the treatment with an alkali. It follows that the outer air, from which the hydrogen sulfide gas has been removed, flows into the casing 11 through the second oxidizing section 58b and the second filter 56b.

On the other hand, the air flowing from within the casing 11 into the outside through the air communication hole 62 passes through the second filter 56b, the second oxidizing section 58b, the trapping section 60 and the first oxidizing section 58a so as to flow to the outside of the casing 11 through the air communication hole 62. When the air passes through the second oxidizing section 58b, the hydrogen sulfide gas contained in the air is oxidized by the oxidizing agent so as to form sulfur dioxide and sulfate ions. When the air passes through the trapping section 60, the sulfur dioxide and sulfate ions thus formed are trapped by the trapping section 60 by the neutralizing (ionic) reaction with the trapping agent subjected to the treatment with an alkali. It follows that the air within the casing 11, from which the hydrogen sulfide gas has been removed, is discharged to the outside of the casing 11 through the first oxidizing section 58a, the first filter 56a, and the air communication hole 62.

It is desirable for the first and second oxidizing sections 58a, 58b to be arranged in the site where these oxidizing sections 58a, 58b are sufficiently brought into contact with the air. It should be noted that the oxidizing agent forming the first and second oxidizing sections 58a, 58b is reduced by oxidizing the hydrogen sulfide gas or the like. However, the oxidizing agent is oxidized again by the contact with the air. It follows that the oxidizing power of the oxidizing agent is restored so as to make it possible to use the oxidizing agent substantially permanently.

The HDD of the construction described previously was arranged within an exposing apparatus in which the HDD was exposed to the air containing 1 ppm of a hydrogen sulfide gas, and the HDD was operated for every 30 minutes. Under this condition, an air respiration test was conducted 100 times between the inner space of the casing 11 and the outside of the casing 11 through the air communication hole 62. Then, the HDD was taken out of the exposing apparatus. Further, the chemical filter 50 was taken out of the HDD so as to analyze the sulfur components trapped by the trapping section 60 by using a CS analyzer manufactured by LECO Inc. It has been found that 62 ng of the sulfur components were trapped relative to the theoretical value of 70 ng of the sulfur components. It follows that the chemical filter 50 is capable of trapping not less than about 88% of the oxides of hydrogen sulfide, i.e., sulfur dioxide and sulfate ions.

According to the HDD constructed as described above, there is provided the chemical filter 50. The gaseous component generated inside and outside the casing 11, e.g., a hydrogen sulfide gas, is oxidized by the first or second oxidizing section 58a or 58b, and the formed oxide is trapped by the trapping section 60 by the neutralizing (ionic) reaction with the trapping section 60 arranged in the chemical filter 50. As a result, the gaseous component adversely affecting the parts within the casing 11 can be removed efficiently so as to make it possible to obtain an HDD with an improved reliability.

It should also be noted that the oxidizing sections and the trapping section are arranged to form a laminate structure within the chemical filter 50, with the result that the air flowing into the chemical filter 50 flows through the oxidizing section into the trapping section. It follows that the gaseous component within the air can be oxidized without fail by the oxidizing agent, and the resultant oxide can be trapped without fail by the trapping agent.

The chemical filter 50 of the HDD according to a second embodiment of the present invention will now be described. As shown in FIG. 3, according to the second embodiment of the present invention, the container 52 of the chemical filter 50 comprises a first partition 64a between the first oxidizing section 58a and the trapping section 60, and a second partition 64b between the second oxidizing section 58b and the trapping section 60. The container 52 also comprises a bottom wall 66 arranged in place of the first filter. The outer surface of the bottom wall 66 is in contact with the bottom wall 12a of the casing 11.

The first air passage port 54a is formed in one end portion of the bottom wall 66 of the container 52 so as to communicate with the air communication hole 62 formed in the bottom wall 12a of the casing 11. Also, a first air communication port 68a that permits the first oxidizing section 58a to communicate with the trapping section 60 is formed in the first partition section 64a. The first air communication port 68a is formed in an end portion of the first partition 64a remote from the first air passage port 54a. Further, a second air communication port 68b that permits the second oxidizing section 58b to communicate with the trapping section 60 is formed in the second partition 64b. The second air communication port 68b is formed in the second partition 64 and is positioned remote from the first air communication port 68a.

The second embodiment is equal to the first embodiment in the other parts and, thus, the same portions of the chemical filter 50 are denoted by the same references numerals so as to avoid an overlapping description.

According to the second embodiment of the present invention constructed as described above, the outer air flowing into the casing 11 through the air communication hole 62 flows into the first oxidizing section 58a through the first air passage port 54a and, then, into the trapping section 60 through the first air communication port 68a. The outer air flowing into the trapping section 60 further flows into the second oxidizing section 58b through the second air communication port 68b and, then, into the casing 11 through the second filter 56b.

When the outer air passes through the first oxidizing section 58a, the gaseous component contained in the outer air, e.g., a hydrogen sulfide gas, is oxidized by the oxidizing agent into sulfur dioxide and sulfate ions. When the outer air passes through the trapping section 60, the sulfur dioxide and sulfate ions formed in the first oxidizing section 58a are trapped by the trapping section 60 by the neutralizing reaction with the trapping agent subjected to the treatment with an alkali. It follows that the outer air, from which the hydrogen sulfide gas has been removed, flows into the casing 11 through the second oxidizing section 58b and the second filter 56b.

On the other hand, the air flowing from within the casing 11 to the outside through the air communication hole 62 flows into the second oxidizing section 58b through the second filter 56b and, then, into the trapping section 60 through the second air communication port 68b. The air flowing through the trapping section 60 further flows into the first oxidizing section 58a through the first air communication port 68a and, then, to the outside of the casing 11 through the first air passage port 54a and the air communication hole 62. When the air passes through the second oxidizing section 58b, the hydrogen sulfide gas contained in the gas is oxidized by the oxidizing agent so as to form sulfur dioxide and sulfate ions. When the air further passes through the trapping section 60, the sulfur dioxide and sulfate ions formed in the second oxidizing section 58b are trapped by the trapping section 60 by the neutralizing reaction with the trapping agent. It follows that the air within the casing 11, from which the hydrogen sulfide gas has been removed, is discharged to the outside of the casing 11 through the first oxidizing section 58a, the first air passage port 54a and the air communication hole 62.

As described above, the second embodiment produces the function and effect similar to that produced by the first embodiment described previously. Further, according to the second embodiment of the present invention, the first oxidizing section 58a and the trapping section 60 are separated from each other by the first partition 64. Likewise, the second oxidizing section 58b and the trapping section 60 are separated from each other by the second partition 64b. What should also be noted is that the first air communication port 68a formed in the first partition section 64a is positioned remote from the air communication hole 62. Similarly, the second air communication port 68b formed in the second partition section 64b is positioned remote from the first air communication port 68a. It follows that the outer air flowing into the first oxidizing section 58a through the communication port 62 flows over a long distance within the first oxidizing section 58a. Also, the outer air flowing into the trapping section 60 flows over a long distance within the trapping section 60 and, then, flows into the second oxidizing section 58a. It follows that the gaseous component contained in the outer air flowing into the chemical filter 50 can be oxidized without fail in the first oxidizing section 58a, and the formed oxide can be trapped without fail by the trapping section 60.

In the second embodiment of the present invention, it is possible for the container 52 to comprise a ceiling wall formed integral with the container 52 in place of the second filter 56b and for the second air communication port to be formed in the ceiling wall. In this case, it is desirable for the second air communication port to be formed in the end portion remote from the second air communication port 68b as in the second embodiment so as to allow the gaseous component contained in the air flowing from within the casing 11 into the chemical filter 50 to be oxidized and trapped without fail.

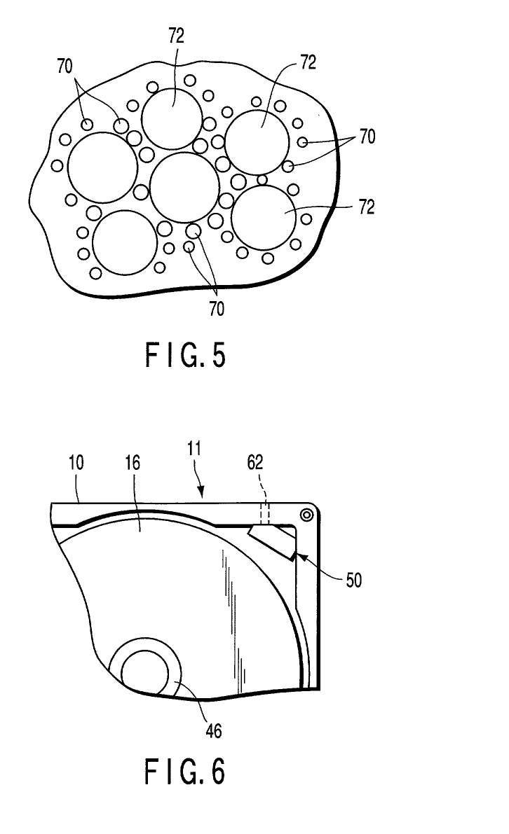

In the chemical filter according to each of the embodiments described above, the oxidizing agent and the trapping agent are housed in the container 52 to form separate layers. Alternatively, it is also possible to house the oxidizing agent and the trapping agent in the container 52 in a manner to form a mixed layer, as shown in FIGS. 4 and 5.

To be more specific, in the chemical filter 50 for the HDD according to a third embodiment of the present invention, the first and second air passage ports 54a, 54b are closed by the first and second filters 56a, 56b, respectively. Also, the chemical filter 50 is fixed on the bottom wall 12a in a manner to close the air communication hole 62 of the casing 11. In this case, the chemical filter 50 is arranged such that the air communication hole 62 is surrounded by the container 52 under the state that the first filter 56a is in contact with the inner surface of the bottom wall 12a.

Within the container 52, the oxidizing agent for oxidizing the gaseous component and the trapping agent for trapping the oxidized gas are housed in a mixed state in the clearance between the first and second filters 56a and 56b. It is possible to use the oxidizing agent and the trapping agent equal to those described previously in conjunction with the first embodiment. As shown in FIG. 5, the oxidizing agent 70 and the trapping agent 72 are mixed such that the oxidizing agent particles 70 are dispersed to surround each of the trapping agent particles 72. Where, for example, a powdery cobalt oxide is used as the oxidizing agent, the cobalt oxide powder has a particle diameter of about 1 nm to 500 nm. Also, where an activated charcoal subjected to the treatment with an alkali is used as the trapping agent, the particle diameter of the trapping agent is about 0.5 μm to 1.0 μm. Further, the mixing ratio of the oxidizing agent to the trapping agent is set at about 100:1.

The third embodiment is equal to the other embodiments in the other parts and, thus, the same portions of the chemical filter 50 are denoted by the same reference numerals so as to avoid an overlapping description.

It is also possible for the third embodiment of the construction described above to oxidize the gaseous component contained in the air flowing within the chemical filter 50 by the oxidizing agent and, then, to trap and remove the formed oxide by the trapping agent.

The present invention is not limited to the embodiments described above and can be modified in various fashions within the technical scope of the present invention. For example, the arranging position of the chemical filter 50 can be selected optionally within the casing 11. In the example shown in FIG. 6, the chemical filter 50 is arranged in the vicinity of the magnetic disk 16 and in a corner portion of the casing 11. In this case, it is possible to form the air communication hole 62 communicating with the chemical filter 50 in any of the side wall, the bottom wall and the cover of the casing 11. Further, the present invention may be applied to another disk apparatus such as an optical disk apparatus.

Additional advantages and modifications will readily occur to those skilled in the art. Therefore, the present invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk apparatus, comprising:
a motor configured to support and drive a disk;
a head configured to read information from the disk;
a casing having a substantially hermetic structure, which houses the disk, the motor, and the head; and
a filter arranged within the casing;
the filter including an oxidizing agent containing oxidized metal components and serving to oxidize gaseous components, and a trapping agent subjected to the treatment with an alkali, for trapping the acidic gas oxidized by the oxidizing agent.

2. The disk apparatus according to claim 1, wherein the filter includes a container provided with first and second air passage ports, and the oxidizing agent and the trapping agent are housed in the container in a mixed state such that the mixture is positioned between the first and second air passage ports.

3. The disk apparatus according to claim 1, wherein the filter includes a container provided with first and second air passage ports, an oxidizing section including the oxidizing agent housed in the container and arranged to close at least one of the first and second air passage ports, and a trapping section including the trapping agent housed in the container and arranged adjacent to the oxidizing section.

4. The disk apparatus according to claim 3, wherein the container includes a partition between the oxidizing section and the trapping section, and an air communication port formed in the partition to allow the air communication between the oxidizing section and the trapping section.

5. The disk apparatus according to claim 1, wherein the filter includes a container provided with first and second air passage ports, a first oxidizing section including the oxidizing agent housed in the container and arranged to close the first air passage port, a second oxidizing section including the oxidizing agent housed in the container and arranged to close the second air passage port, and a trapping section including the trapping agent housed in the container and positioned between the first and second oxidizing sections.

6. The disk apparatus according to claim 5, wherein the container includes a first partition between the first oxidizing section and the trapping section, a first air communication port formed in the first partition to allow the air communication between the first oxidizing section and the trapping section, a second partition between the second oxidizing section and the trapping section, and a second air communication port formed in the second partition to allow the air communication between the second oxidizing section and the trapping section.

7. The disk apparatus according to claim 2, wherein the casing is provided with an air communication hole allowing the outer air to communicate with the air inside the casing, and the filter is arranged to close the air communication hole and to allow one of the first and second air passage ports to communicate with the air communication hole of the casing.

8. The disk apparatus according to claim 3, wherein the casing is provided with an air communication hole allowing the outer air to communicate with the air inside the casing, and the filter is arranged to close the air communication hole and to allow one of the first and second air passage ports to communicate with the air communication hole of the casing.

9. The disk apparatus according to claim 1, wherein the oxidizing agent includes an oxide of at least one metal selected from the VIIA to VIIIA group metals.

10. The disk apparatus according to claim 1, wherein the trapping agent includes at least one material selected from the group consisting of alumina particles, activated charcoal and fibrous material, which are subjected to the treatment with an alkali.

11. A disk apparatus comprising:
a motor configured to support and drive a disk;
a head configured to read information from the disk;
a casing having a substantially hermetic structure, which houses the disk, the motor, and the head; and
a filter arranged within the casing;
the casing including an air communication hole allowing the outer air to communicate with the air inside the casing, and
the filter being arranged to close the air communication hole and including an oxidizing agent for oxidizing gaseous components contained in the air flowing through the air communication hole and a trapping agent subjected to the treatment with an alkali, for trapping the acidic gas oxidized by the oxidizing agent.

12. A disk apparatus, comprising:
a magnetic disk;
a motor configured to support and drive the magnetic disk;
a magnetic head configured to write/read information to/from the magnetic disk;
a casing having a substantially hermetic structure, which houses the disk, the motor, and the magnetic head; and
a filter arranged within the casing;
the filter including an oxidizing agent containing oxidized metal components and serving to oxidize gaseous components, and a trapping agent subjected to the treatment with an alkali, for trapping the acidic gas oxidized by the oxidizing agent.

13. A filter for a disk apparatus comprising:
an oxidizing agent containing oxidized metal components and serving to oxidize gaseous components in a casing of the disk apparatus; and
a trapping agent subjected to the treatment with an alkali, for trapping the acidic gas oxidized by the oxidizing agent.

14. The filter according to claim 13, wherein the filter includes a container provided with first and second air passage ports, and the oxidizing agent and the trapping agent are housed in the container in a mixed state such that the mixture is positioned between the first and second air passage ports.

15. The filter according to claim 13, wherein the filter includes a container provided with first and second air passage ports, an oxidizing section including the oxidizing agent housed in the container and arranged to close at least one of the first and second air passage ports, and a trapping section including the trapping agent housed in the container and arranged adjacent to the oxidizing section.

16. The filter according to claim 15, wherein the container includes a partition between the oxidizing section and the trapping section, and an air communication port formed in the partition to allow the air communication between the oxidizing section and the trapping section.

17. The filter according to claim 13, wherein the filter includes a container provided with first and second air passage ports, a first oxidizing section including the oxidizing agent housed in the container and arranged to close the first air passage port, a second oxidizing section including the oxidizing agent housed in the container and arranged to close the second air passage port, and a trapping section including the trapping agent housed in the container and positioned between the first and second oxidizing sections.
